(19) United States
(12) Patent Application Publication
(10) Pub. No.: US 2024/0054550 A1
(43) Pub. Date: Feb. 15, 2024

(54) ORDER ANALYTICS CAPTURE SYSTEM, SUCH AS FOR QUICK SERVICE RESTAURANTS

(71) Applicant: Marchex, Inc., Seattle, WA (US)

(72) Inventors: Sunny Smith, Benton, KS (US); Michael E. Seeds, Rose Hill, KS (US); Tyson Frevert, Olathe, KS (US)

(21) Appl. No.: 17/885,510

(22) Filed: Aug. 10, 2022

(51) Int. Cl. G06Q 30/06; G06Q 30/02; G06Q 50/12; G10L 25/63; G10L 15/22; G06F 3/16; G06F 3/14

(52) U.S. Cl. CPC G06Q 30/0635; G06Q 30/0282; G06Q 50/12; G10L 25/63; G10L 15/22; G06F 3/165; G06F 3/14

(57) ABSTRACT

A system and methods for analyzing orders is disclosed, such as for quick service restaurants. Audio data is received for multiple orders, the audio data being captured using one or more audio extraction modules via an intercom system. An order analysis model is applied to characterize the audio data, the characterization including estimated customer satisfaction or perceived employee attitude. Based on the characterization, one or more recommendations are generated, including a recommended change in employee behavior to improve customer satisfaction or perceived employee attitude. The order analysis model can comprise a machine learning model trained to characterize audio data for orders.

### BACKGROUND

Quick service restaurants, also known as fast food restaurants, typically offer a limited menu of food options that may be cooked in advance and offered for takeout service, such as via a drive-through ordering system

Various factors affect customer satisfaction when being served at a quick service restaurant, including but not limited to employee attitude, accuracy of order taking, length of customer line, speed of order taking, and speed of order completion.

Managers or operators of restaurants supervise employees and interactions between employees and customers to improve customer satisfaction and to improve performance and profitability. For example, a manager can monitor interactions between an employee and customers via a drive-through intercom system to ensure that the employee performs adequately based on the employee's attitude, friendliness or politeness, accuracy of order taking, speed of order taking, and so forth. Based on these interactions, the manager can provide feedback to the employee and evaluate the employee's performance. In addition, by improving employee performance, customer satisfaction can be increased and drive-through wait times can be decreased. Furthermore, the manager can monitor interactions to determine whether intervention is necessary, for example, to correct an inaccurate order, to respond to a dissatisfied customer, or for other reasons.

However, managers and operators face difficult technical challenges when trying to ensure customer satisfaction and employee performance. For example, managers and operators do not have the time to monitor every customer-employee interaction. Thus, managers and operators may not have a complete or accurate understanding of overall customer satisfaction and employee performance. Moreover, managers and operators are typically unable to monitor customer-employee interactions in real time (e.g., while an order is ongoing) to provide immediate feedback to the employee or to correct an inaccurate order. Furthermore, monitoring all or most employee-customer interactions to provide feedback cannot reasonably be performed by humans due to the large volume of orders taken at quick-service or similar restaurants, which may process hundreds or thousands of orders per day.

Thus, there is a need for systems and methods that overcome the foregoing problems and provide additional benefits. Further limitations of existing or prior systems will become apparent to persons skilled in the art upon reviewing the following Detailed Description.

### BRIEF DESCRIPTION OF THE DRAWINGS

FIG. 1 is a block diagram that illustrates an environment in which an order analytics system operates.

FIG. 2 is a block diagram that illustrates components of an order analytics system.

FIG. 3A is a flow diagram that illustrates a process for training an order analytics system using machine learning.

FIG. 3B is a table that illustrates data associated with orders.

FIG. 4 is a flow diagram that illustrates a process for analyzing an order using an order analytics system.

### DETAILED DESCRIPTION

An order analytics system is disclosed herein, such as for analyzing orders taken via a drive-through ordering system of a quick service restaurant. To analyze orders, the system trains one or more machine learning models based on order data and corresponding actions. As used herein, an “order” includes all interactions between a customer and one or more employees of a business, such as a restaurant, including but not limited to spoken conversation between the customer and the one or more employees. Order data associated with an order includes recorded or transcribed audio of spoken interactions between customers and employees. In some implementations, order data can also include additional data, such as wait time, order duration, line length (e.g., of cars waiting at a drive-through lane), and so forth. To train the one or more machine learning models, order data for multiple orders (e.g., hundreds or thousands of orders) is analyzed and processed to identify various characteristics. These characteristics can be based on various order metrics (e.g., wait times, order duration), which can also include one or more ratings representing employee attitude, customer satisfaction, order accuracy, and so forth. At least a portion of these metrics can be included in a scorecard characterizing an order. At least some orders in the order data are associated with corresponding actions. Actions can be, for example, for the purpose of reducing order times or wait times, increasing customer satisfaction, improving employee attitude or performance, or for other reasons. A training dataset is generated using the analyzed and processed order data, and the training dataset is used to train one or more machine learning models to analyze received orders and characterize the orders. Based on the determined characterization, the system may take one or more actions.

After the one or more machine learning (ML) models have been trained, the models are used to analyze new orders and characterize the orders. For example, the system receives audio of an order being placed via a drive-through intercom system. In some implementations, the system also receives additional information about the order, such as order inputs to a computing system. The system applies one or more ML models to the received audio of the order and characterizes the order. The characterization can include an employee attitude rating and/or a customer satisfaction rating. In addition to applying ML models to the received audio of the order, the system can also employ one or more speech analytics tools, which can perform automatic speech recognition, attitude or sentiment analysis, keyword detection, or other operations. Based on the analysis of the order, the system takes one or more actions. The one or more actions can include providing an indicator to an employee taking the order, such as a suggested behavior to improve the employee's perceived attitude and/or the customer's satisfaction. In some implementations, the one or more actions can include providing a positive reinforcement message to the employee.

To train the one or more machine learning models and to analyze orders, the system can use an audio extraction module coupled to an intercom system or other ordering system of a business. For example, the audio extraction module can comprise a processor and a memory carrying instructions for performing operations to extract order audio from the intercom system. The audio extraction module can identify and separate order interactions for each order. For example, a quick-service restaurant can use various technologies to detect an approaching vehicle, such as induction loop systems, magnetometers, or radar sensors. Using these technologies (e.g., by detecting an audio indicator of an approaching vehicle), the audio extraction module determines that a vehicle is approaching the intercom system to begin an order. Based on this determination, the audio extraction module begins recording audio from the intercom system. In some implementations, the recorded audio is streamed to a computing system, which may be at a remote location, for analysis, as described herein, to characterize the order and to take actions. Upon detecting the end of an order, the audio extraction module stops recording. Detecting the end of the order can be performed, for example, by detecting keywords indicating the end of an order, or based on detecting lack of speech in the recorded audio for a default amount of time. The end of the order may also be determined using technologies to detect a departing vehicle, such as induction loop systems, magnetometers, or radar sensors. Using these technologies (e.g., by detecting the motion of a vehicle off of an induction loop or detecting a tone indicating motion of the vehicle), the audio extraction module determines that the vehicle is departing the location of the intercom system and has therefore presumably completed the ordering process. In addition to delineating order interactions, the audio extraction module can also process the recorded audio, such as by assigning an identifier, adding one or more time stamps, separating the recorded audio into two or more channels (e.g., a customer channel and an employee channel), and so forth.

Advantages of the disclosed system include improved employee performance and customer satisfaction. In addition, the disclosed technology allows for comprehensive monitoring and analysis of a greater number of employee-customer interactions than can be reasonably performed by humans, such as monitoring and analysis of most or all interactions via a drive-through ordering system. Furthermore, the disclosed technology enables enhanced employee evaluation because an employee's performance (e.g., perceived attitude, total sales, overall customer satisfaction) can be assessed across a large number of interactions (e.g., hundreds or thousands of orders).

Generally speaking, the disclosed system can provide comprehensive and configurable order analytics across a large number (e.g., hundreds, thousands, millions) of orders, such as analytics for substantially all orders for a chain of quick service restaurants (e.g., regionally, nationally, internationally). For example, the disclosed system can be used to provide analytics based on various factors, including locations, employees, dates, total order times, wait times (e.g., before ordering, after ordering), order delay time (e.g., caused by the customer or the employee), order repetitions (e.g., a customer repeating all or a portion of an order), order contents or patterns (e.g., most frequently ordered items), and so forth. These analytics can be used to generate various reports and/or analyses, such as reports or analyses summarizing or detailing order characteristics based on timeframes (e.g., day, week, month, year, quarter, year, multi-year period, etc.), locations (e.g., individual restaurant, region, state, country, etc.), employees, and so forth. These reports or analyses can be provided, for example, via graphical user interfaces (GUIs), which can provide various views (e.g., charts or graphs) and/or filters to facilitate evaluation of the reports or analyses. Analyses provided by the system can also be used to generate alerts or notifications, such as automatically generating an alert when one or more order characteristics for a restaurant deviate from a threshold or an average (e.g., lower than average customer satisfaction in a given day, week, month, etc.). Reports or analyses provided by the disclosed system can also be used to improve operations for businesses (e.g., quick service restaurants), such as by helping to identify characteristics that improve customer satisfaction, increase sales, reduce order times or wait times, and so forth.

For purposes of illustration, specific examples are provided herein related to quick service restaurants or similar businesses using a drive-through ordering system. However, these examples are non-limiting, and the disclosed technology can be applied in any environment wherein interactions between two or more parties occur at a physical service location and/or via intercom systems. For example, the disclosed technology can be applied to banking services, pharmacies, other drive-through services, and so forth.

Various embodiments of the invention will now be described. The following description provides specific details for a thorough understanding and an enabling description of these embodiments. A person skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is used in conjunction with a detailed description of certain example embodiments of the invention.

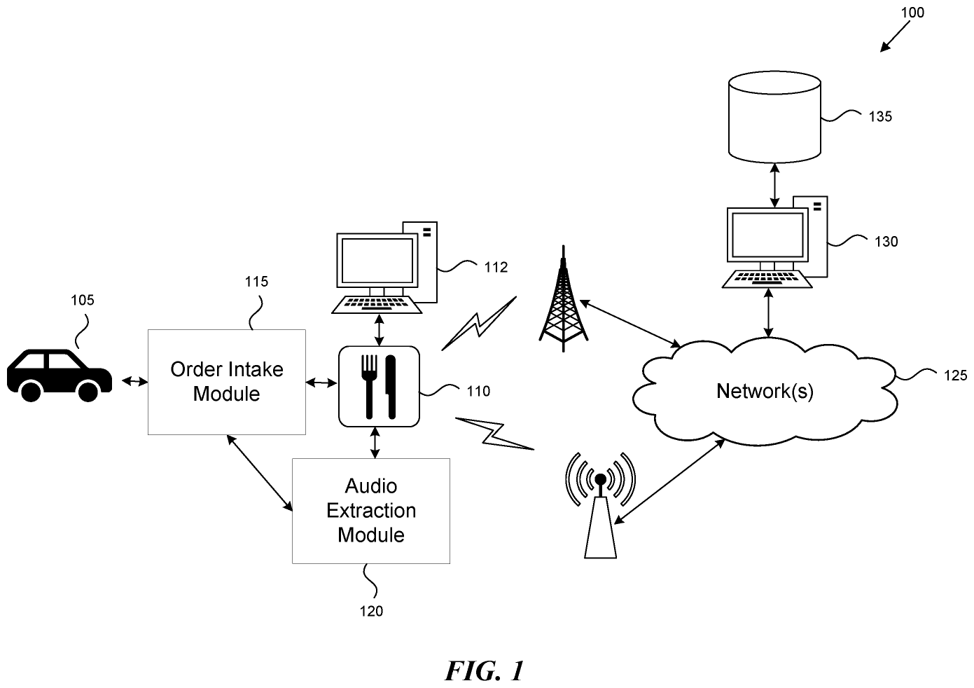

FIG. 1 is a block diagram that illustrates an environment 100 within which a call analytics system operates. In the environment 100, a customer 105 places an order at a restaurant 110 or other establishment having a physical service location. The customer 105 can be in a vehicle in a drive-through lane of the restaurant 110. An interaction (e.g., a spoken conversation) occurs between the customer 105 and an employee of the restaurant 110 to take the customer's order. The interaction can occur via an order intake module 115, which includes an intercom system, such as a system provided by HM Electronics, Inc., of Carlsbad, California or 3M Company of Maplewood, Minnesota. During the interaction, the employee also enters order inputs into a computing system 112 of the restaurant 110, including items ordered by the customer 105. In some implementations, the order inputs can additionally or alternatively be entered in other ways, such as using automated speech recognition systems.

As the employee takes the customer's order, the interaction is also captured by an audio extraction module 120. The audio extraction module 120 comprises hardware, software, or a combination of hardware and software, that records the interaction between the customer 105 and the employee of the restaurant 110. For example, the audio extraction module 120 can record audio of the interaction and, in some implementations, transcribe the audio. The audio extraction module 120 can also process the audio in other ways, such as by identifying start and end times of an order, generating time stamps, and separating audio into individual files (e.g., WAV files or MP3 files) each including one order. In an example implementation, the audio extraction module 120 detects a start time of an order based on detecting presence of a vehicle using one or more vehicle detection technologies, such as inductive loop systems, radar, or wireless magnetometers. Typically, vehicle detection technologies will generate a tone on the intercom indicating the presence of a new vehicle. That tone can be, for example, a 3 kHz tone, which can be detected by the audio extraction module 120 to signal the start time of a new order. The system may capture audio until a next tone is received (signaling the next car/order), until a certain period of time elapses without detection of audio on the intercom, until a certain elapsed time is reached (e.g., a 5-minute timeout period if a next tone is not detected), etc. In some implementations, the audio extraction module 120 can determine start or end times of an order based on detecting keywords in order audio. For example, “Welcome to . . . ” or a similar phrase can signal the start of an order interaction, while “ . . . at the first drive-through window” or a similar phrase can signal the end of an order interaction. In some implementations, audio can be separated into different channels, such as a customer channel and an employee channel, which can be analyzed separately.

The audio extraction module 120 typically captures the order audio file on-site at the restaurant 110. The audio extraction module 120 then transmits the captured audio to an order analytics system 130 via one or more networks 125. The one or more networks 125 can include, for example, private or public wired or wireless networks such as the Internet. Additional information can also be transmitted from the restaurant to the order analytics system 130, such as order inputs entered into a computing system 112 of the restaurant 110 by the employee. The order analytics system 130 analyzes the recorded interaction and any additional information based on one or more models, which can be machine learning models, stored in one or more data storage areas 135. In some embodiments, the order audio is aggregated at the restaurant by the audio extraction module 120 and periodically transmitted in larger files to the order analytics system 130. For example, audio files of 5-20 MB comprising multiple orders may periodically be transmitted by the audio extraction module to the order analytics system 130. In some embodiments, the audio associated with each order may be transmitted as it is received by the audio extraction module 120 (e.g., in real time, near-real time, or upon completion of an order). The audio extraction module 120 will also append one or more time and date stamps to each recording (e.g., an order start time and/or an order end time), reflecting the time of the recording, and a unique ID or location associating the recording with the particular restaurant 110 or other physical service location at which it was captured. The restaurant or physical service identifier may be configured at the time of order analytics system deployment, with different unique identifiers associated with each deployed location. In some implementations, the audio extraction module 120 associates each recording with additional supplemental information, such as an identifier (e.g., name or employee ID number) of an employee taking the order, a list of items in an order, and/or one or more time stamps. The employee identifier and order information may be provided by a point of sale system used to take the associated order. Alternatively, the identity of the employee may be determined after recording of the order audio by the order analytics system processing the order audio and matching the audio with employee voiceprints.

In some embodiments, the audio extraction module 120 pre-processes the audio file before transmission to the order analytics system 130. The audio file may be captured at a high-quality (e.g., CD-quality) sampling rate and may be stored in a common audio format (e.g., WAV or MP3 format). Prior to transmission, the audio file may be compressed to reduce transmission bandwidth and/or encrypted to provide transmission security. The audio extraction module 120 may also pre-process the audio to remove silence, to normalize the volume level, to remove the new vehicle 3 kHz detection tone, or to otherwise remove noise and improve the audio quality.

As will be described in additional detail herein, the order analytics system 130 analyzes the order audio and other received information using one or more ML models or other techniques. Based on the analysis, the order analytics system 130 identifies one or more characteristics of the order and takes one or more actions. For example, feedback can be provided to indicate attitude (e.g., politeness or friendliness) of the employee, customer satisfaction or dissatisfaction, or duration of order. In some implementations, the order analytics system can provide audio or visual feedback to an employee, such as when an employee's attitude is perceived as negative, when an employee should increase the speed of order taking, and so forth. In some implementations, the feedback is for the purpose of positive reinforcement, for example, to encourage an employee to maintain behaviors that are associated with a positive employee attitude or customer satisfaction. Other feedback can include suggestions to upsell and suggestions for a supervisor to intervene in an order. In some implementations, the order analytics system generates one or more reports characterizing the performance of the employee taking the order and transmits the report to a computing system of the restaurant or other physical service location where the order was taken.

To provide feedback, the order analytics system can cause display of a graphical user interface at a computing system 112 used by the employee or a supervisor of the employee, and the visual indicators can be displayed at the graphical user interface. Additionally or alternatively, the order analytics system 130 can cause audio indicators to be played, such as via a speaker or headset via which the employee accesses the intercom system.

In some implementations, the order analytics system takes other actions based on the analysis of the recorded interaction. For example, the order analytics system can track an employee across multiple orders (e.g., using speech-based recognition or based on employee self-identification in order audio) and evaluate employee performance, such as based on the employee's attitude, average order duration or wait time, sales metrics, upselling, overall customer satisfaction, overall accuracy of order taking, and so forth. In these and other implementations, the employee can be identified (e.g., based on biometric indicators in the employees speech and/or self-identification in order audio) and multiple orders can be identified that are associated with the employee, such that the employee's performance (e.g., attitude, customer satisfaction, accuracy, wait times or order times) can be assessed over time. Additionally or alternatively, the order analytics system can provide or facilitate analyses or reports for individual restaurants or multiple restaurants (e.g., across a region, state, country, etc.) based on order characteristics and/or restaurant performance (e.g., customer satisfaction, sales, etc.).

Although not required, aspects of the system are described in the general context of computer-executable instructions, such as routines executed by a general-purpose computer, a personal computer, a server, or other computing system. The system can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the system can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the system described herein may be stored or distributed on tangible, non-transitory computer-readable media, including magnetic and optically readable and removable computer discs, stored in firmware in chips (e.g., EEPROM chips). Alternatively, aspects of the system may be distributed electronically over the Internet or over other networks (including wireless networks). Those skilled in the relevant art will recognize that portions of the system may reside on a server computer, while corresponding portions may reside on a client computer.

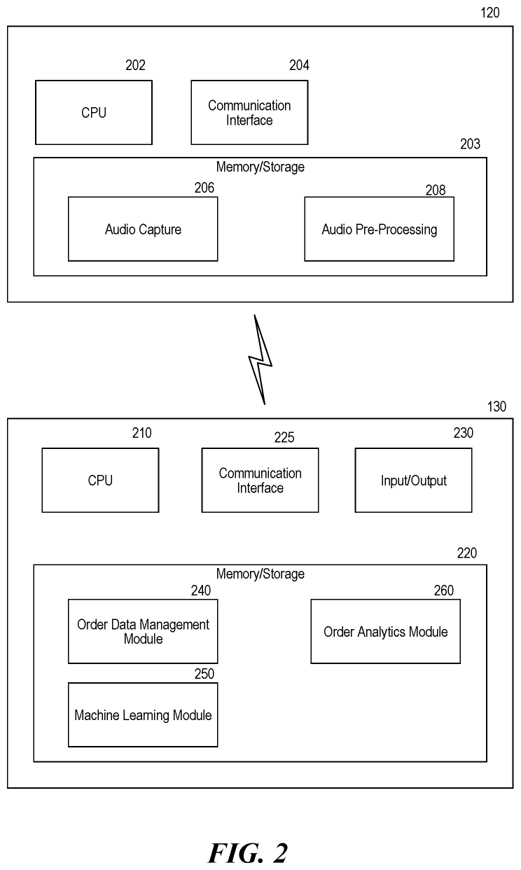

FIG. 2 is a block diagram that illustrates components of the audio extraction module 120 and the order analytics system 130. The audio extraction module 120 includes various modules, which can be implemented as hardware, software, or a combination of hardware and software. As shown in FIG. 2, the audio extraction module 120 includes one or more central processing units (CPU) 202 for executing software stored in one or more memories 203 or other storage. The audio extraction module 120 also includes a communication interface module 204 such as an Ethernet interface, USB interface, FireWire interface, or other wired or wireless interface that allows the audio extraction module 120 to transmit and receive data from other devices or systems, such as the order analytics system 130.

The memory 203 stores software modules that perform various operations of the audio extraction module 120, and can include components, subcomponents, or other logical entities that assist with or enable performance at least some operations of the audio extraction module 120. The modules include an audio capture module 206 and an audio pre-processing module 208, each of which will be described in more detail below.

The audio capture module 206 captures and records audio of orders placed via an intercom system. For example, the audio capture module 206 can connect to an intercom system of a restaurant and receive audio signals from the intercom system. For example, some intercom systems provide a headphone jack, Bluetooth connection, or other wireless connection to connect with the system and send or receive audio data. In some implementations, the audio capture module 206 can additionally or alternatively receive audio via one or more separate microphones or other means for capturing audio information. The separate microphone or microphones may be placed adjacent or near the microphones of the existing intercom system, such as at the exterior menu board where a customer typically orders from their automobile or at the interior register where a restaurant employee captures the customer's order. The audio capture module 206 records the captured audio in one or more audio files, such as WAV or MP3 files. As described herein, the audio capture module 206 can begin recording audio when a vehicle is detected using vehicle detection technology, such as in response to a 3 kHz tone that signals the arrival of a new vehicle. The audio capture module continues recording until the end of an order, such as when the audio capture module 206 detects silence for a predetermined amount of time or when a tone is received to signal the beginning of another order. The audio capture module 206 can, additionally or alternatively, stop or terminate recording after a predetermined timeout period (e.g., after five minutes). The audio capture module 206 can separate orders into individual audio files and associate each order with metadata, such as one or more date and time stamps (e.g., an order start time and an order end time), a location where the order was captured, an identifier for the order, and so forth. After the order is captured in an audio file, the audio extraction module 120 sends the audio file to the order analytics system 130, either individually or in a batch together with other audio files.

In some implementations before sending the audio file to the order analytics system 130, the audio file is pre-processed by the audio pre-processing module 208. The audio pre-processing module 208 pre-processes the audio file in various ways, such as to remove noise, normalize the volume level, compress the audio file, remove silence, encrypt the audio file, and so forth. The audio extraction module 120 sends the pre-processed audio file to the order analytics system 130, either individually or in a batch together with other audio files (e.g., hourly, daily, weekly, etc.).

The order analytics system 130 can be implemented, for example, using one or more computer servers and data storage area 135 of FIG. 1. The system 130 includes various modules, which can be implemented as hardware, software, or a combination of hardware and software. As shown in FIG. 2, the system 130 includes one or more central processing units (CPU) 210 for executing software stored in one or more memories 220 or other storage. The system 130 also includes one or more input/output (I/O) modules 230 coupled to the CPU 210. The I/O module(s) 230 allow data to be either input to the system 130 by a user (e.g., from a keyboard, mouse, touchpad or touch panel) or output to another device (e.g., a monitor, computer, printer, or other output mechanism). The system 130 also includes a communication interface module 225 such as an Ethernet interface, USB interface, FireWire interface, or other wired or wireless interface that allows the order analytics system 130 to transmit and receive data from other devices, such as the audio extraction module 120.

The memory 220 stores software modules that perform various operations of the system 130, and can include components, subcomponents, or other logical entities that assist with or enable performance at least some operations of the system 130. The modules include an order data management module 240, a machine learning module 250, and an order analytics module 260, each of which will be described in more detail below.

The order data management module 240 aggregates and processes order data received by the system 130. The order data management module 240 can, for example, store received audio of order interactions, which can be stored as individual audio files or text files of transcribed audio, each containing a single order interaction. In some implementations, the order data management module 240 can also associate audio of order interactions with corresponding additional order data, such as order inputs entered into a computing system by an employee of a restaurant.

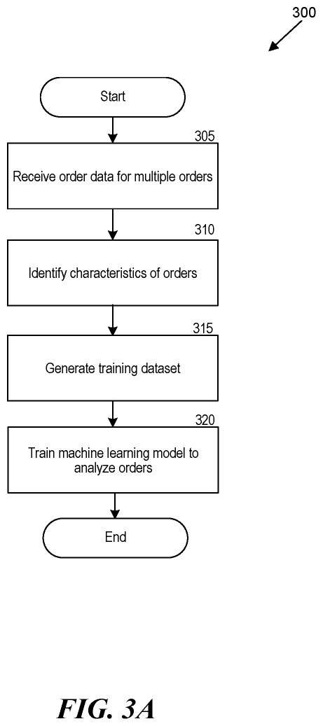

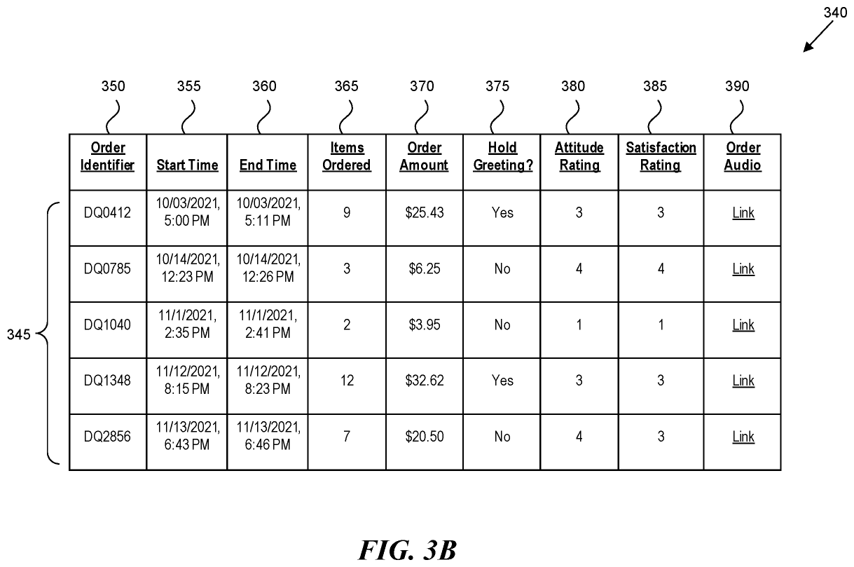

In some implementations, order data stored by the order data management module 240 includes scorecards characterizing orders. Scorecards allow for various predetermined order characteristics or metrics to be programmatically recorded. Scorecards can include a variety of metrics, which will be described in detail below in relation to FIG. 3B. These metrics can include numerical ratings of employee attitude (e.g., friendliness or politeness), customer satisfaction, and other order attributes, as further explained below. Other metrics that can be included in a scorecard include order duration (e.g., based on order start time and stop time), total quantity of items ordered, total sales during an interaction (e.g., in dollars), and specific content in an order interaction (e.g., keywords, pauses, sighing, laughing, shouting, etc.). For example, a scorecard can indicate whether an employee in the interaction used a “hold greeting” to delay the beginning of an order (e.g., “Welcome to [______]. We'll be with you in a moment.”), which may decrease customer satisfaction and be used by an employee to create the appearance of decreased wait times. A scorecard can also indicate whether an employee in the interaction attempted to upsell the customer, whether the employee used appropriate or inappropriate language or greetings, whether a customer had to repeat all or part of an order, and so forth. Additional examples of characteristics that can be documented in a scorecard include menu items suggested by an employee, menu items ordered by a customer, names (e.g., employee name), salutations, indications of the end of an order (e.g., parting words), presence or absence of profanity or other inappropriate language, cadence, volume, interruptions or crosstalk, response time (e.g., between customer speech and employee speech), and or instances of suggestive selling or upselling.

Scorecards used for training purposes by the system are initially manually generated by a person who reviews audio associated with different orders and scores those orders on a number of different metrics enumerated herein. As the system becomes trained, subsequent training scorecards can be generated automatically (e.g., by a computing system) with manual review/confirmation of the resulting generated scorecard (e.g., by a person). Once the system has been configured, scorecards associated with new orders are automatically generated by the system by application of ML models or other analyses to received order data.

Data stored by the order data management module 240, including scorecards, can be used to generate one or more training datasets to train one or more machine learning models (“ML models”) by the machine learning module 250. Once trained, the ML models are used to automatically assess interactions between employees and customers in newly received orders based on captured audio and order information.

A “model,” as used herein, can include a construct that is trained using training data to make predictions or provide probabilities for new data items, whether or not the new data items were included in the training data. For example, training data for supervised learning can include items with various parameters or characteristics and an assigned classification. A new data item can have parameters or characteristics that a model can use to assign a classification to the new data item or take other actions. As another example, a model can be a probability distribution resulting from the analysis of training data, such as a likelihood of an n-gram occurring in a given language based on an analysis of a large corpus from that language. Examples of models include, without limitation: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, a ML model trained by the machine learning module 250 can be a neural network with multiple input nodes that receive order data, such as audio of order interactions and/or additional order data. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer (“the output layer”), one or more nodes can produce a value classifying the input that, once the model is trained, can be used to analyze orders. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes order data, such as audio and other order information, as input and a desired output, such as one or more metrics characterizing an order interaction and/or actions to take in response to analyzing an order interaction. A representation of an order interaction can be provided to the model. Output from the model can be compared to the desired output for that order interaction and, based on the comparison, the model can be modified, such as by changing weights between nodes of the neural network or parameters of the functions used at each node in the neural network (e.g., applying a loss function). After applying each of the order interactions in the training data and modifying the model in this manner, the model can be trained to evaluate new order interactions.

In addition to audio recordings of orders, training datasets used by the machine learning module 250 to train the one or more machine learning models can include various data about orders, such as order duration, number of items ordered, order total, delay time to begin taking an order (e.g., by comparing a time that a vehicle is detected and a time when an employee begins taking an order), and so forth. Some training data can include numerical ratings characterizing orders or order interactions obtained from an order scorecard, such as based on perceived attitude of an employee taking an order, customer satisfaction, or order accuracy. Table 1 below illustrates an example of a rating system by which attitude of an employee taking an order has been characterized by a person who provides data to be included in a training dataset.

TABLE 1

| Attitude Rating | |
|---|---|
| (e.g., “politeness”) | Interaction Attributes |
| 1 (Negative) | Employee attitude perceived as poor based on, |
| | e.g., tone of voice, incidents of rudeness (e.g., |
| | interruptions, foul language), lack of |
| | enthusiasm |
| 2 (Somewhat Negative) | Employee attitude perceived as poor based on, |
| | e.g., tone of voice, mild rudeness, lack of |
| | enthusiasm |
| 3 (Mostly Positive) | Employee attitude perceived as mostly positive |
| | based on, e.g., tone of voice, few or no |
| | incidents of rudeness, fair enthusiasm |
| 4 (Highly Positive) | Employee attitude perceived as highly positive, |
| | e.g., based on tone of voice, use of appropriate |
| | greeting, no incidents of rudeness, high |
| | enthusiasm |

Similarly, training datasets can include numerical ratings of customer satisfaction based on various attributes of order interactions or other order data, as illustrated in the below Table 2.

TABLE 2

| Customer Satisfaction | |
|---|---|
| Rating | Interaction Attributes |
| 1 (Very Dissatisfied) | Customer appears very dissatisfied based on, |
| | e.g., customer tone of voice, many negative |
| | vocalizations (e.g., sighing, repeating order |
| | multiple times, shouting, raised voice), very |
| | long wait times or order times |
| 2 (Somewhat Dissatisfied) | Customer appears somewhat dissatisfied |
| | based on, e.g., customer tone of voice, some |
| | negative vocalizations, somewhat long wait |
| | times or order times |
| 3 (Mostly Satisfied) | Customer appears generally satisfied based |
| | on, e.g., tone of voice, general positive |
| | vocalizations, short wait times, few or no |
| | order corrections |
| 4 (Highly Satisfied) | Customer appears highly satisfied based on, |
| | e.g., tone of voice, all positive |
| | vocalizations, very short wait times |

Tables 1 and 2 illustrate examples of rating systems for various attributes characterizing an order. Other rating systems are possible, such as numerical rating systems using different scales (e.g., 0-100) and non-numerical systems (e.g., letter grades). Furthermore, such rating systems can be applied to other order characteristics. For example, other ratings can provide an indication of order accuracy, where a low score indicates many errors in taking a customer's order and a high score indicates no errors.

The foregoing ratings and other ratings are contained in training data scorecards associated with each order, as well as the original audio order data and other order information, that are used by the machine learning module 250 to train one or more machine learning models. In some implementations, different subsets of data and/or ratings can be used to train different models. For example, a first model can be trained to generate employee attitude ratings, while a second model can be trained to generate customer satisfaction ratings. In these and other implementations, the one or more machine learning models are trained by the machine learning module 250 and stored as the order analytics module 260, which is used to analyze new orders.

Training the one or more machine learning models can include training the model to generate one or more ratings or characterizations of an order based on audio information associated with the order and/or other order data. For example, the machine learning model can be trained to generate employee attitude ratings, customer satisfaction ratings, or other ratings based on rating systems described herein above. In some implementations, the one or more machine learning models are trained to generate ratings representing a probability of a rating based at least in part on order audio. For example, an employee attitude rating generated by a trained machine learning model indicates a probability that an employee's attitude is perceived as positive or negative based on the employee's tone of voice, keywords or phrases, or other information in order audio. Once machine learning models have been trained by the system, the models are used to analyze audio and order information associated with new orders.

The order analytics module 260 applies the one or more machine learning models trained by the machine learning module 250 and generates one or more ratings characterizing an order. To analyze orders, the order analytics module 260 can also employ one or more speech analytics models. The order analytics module 260 receives input comprising audio of an order interaction between a customer and an employee. The audio can, optionally, be transcribed using speech-to-text applications such as those sold by Nuance Communications. In some implementations, the order analytics module 260 can receive additional order data, such as corresponding order inputs entered into a computing system of a restaurant, which can include items included in an order, order total, and so forth. The order analytics module 260 then identifies various metrics characterizing an order, such as order duration or wait times. These metrics can also include one or more ratings, as described above with reference to Tables 1 and 2. For example, the order analytics module 260 can apply trained ML models to rate an employee's perceived attitude, mood, or other characteristics of a speaker based on verbal and non-verbal audio, such as spoken words or phrases, pauses, and/or noises (e.g., laughing, groaning, sighing, etc.). The trained ML models can also be used to assess a customer's estimated satisfaction or dissatisfaction. Based on any combination of metrics characterizing the order, including one or more ratings, the order analytics module 260 can take one or more actions. These actions can include generating an audio or visual prompt to an employee taking an order, such as a prompt to improve his or her perceived attitude and/or to correct a condition causing customer dissatisfaction. Examples of generated metrics and corresponding actions are illustrated in Table 3 below.

TABLE 3

| Metrics/Detected Conditions | Action |
|---|---|
| Long wait time to begin order | Generate prompt to begin order |
| Long order duration | Generate prompt to remove customer from |
| | line, move customer to a waiting area |
| Low customer satisfaction | Generate prompt to apologize to customer, |
| | offer a customer reward |
| Poor employee attitude | Generate prompt to improve attitude, |
| | exhibit more enthusiasm |
| Multiple interactions with | Generate prompt for supervisor to remove |
| poor employee attitude | employee from a drive-through window |
| and/or low customer | |
| satisfaction | |

The foregoing actions are non-limiting examples. Actions can be based on individual order interactions and/or behaviors detected across multiple interactions. Other actions include, for example, recommending that an employee be rewarded for consistently high customer satisfaction and/or consistently positive perceived attitude. For example, a low attitude rating can be associated with an action to suggest that an employee behave in a friendlier way (e.g., use a positive tone of voice, use more positive word choice, etc.) or for a supervisor to intervene. A long wait time (e.g., measured from the time that a car is detected) can be associated with an action to suggest that an employee begin taking an order.

In some implementations, the order analytics module 260 takes actions in real time or near-real time (e.g., while an order is being taken), such that an employee can receive substantially immediate feedback regarding an order that is being taken. For example, the order analytics module 260 can generate suggestions for an employee to change a tone of voice when the employee's attitude is perceived to be poor. Additionally or alternatively, the order analytics module 260 can generate an overall performance score for an order as the order is being taken, and the order analytics module 260 can provide the overall performance score to the employee during the order.

In addition to ratings assessed via application of ML models to the audio data, the order analytics module 260 may also apply one or more other speech analytics tools to supplement the analysis. For example, the speech analytics tools can detect words spoken in received audio, such as keywords or phrases. For example, the order analytics module 260 can use one or more speech analytics tools to characterize a call based on whether an employee uses certain acceptable or unacceptable keywords or phrases. Swear words or other negative words or vocalizations (e.g., shouting) can be associated with a negative attitude and/or low customer satisfaction. Positive words or vocalizations (e.g., approved greetings) can be associated with a positive attitude and higher customer satisfaction.

In some implementations, the order analytics module 260 analyzes orders based on timeframes. For example, the order analytics module 260 can evaluate perceived attitude of a customer or an employee at regular intervals (e.g., every 10 second, 30 seconds, one minute, etc.) and/or at different times during an order (e.g., at the beginning of an order and at the end of an order). In some implementations, the order analytics module 260 provides further analyses of orders based on timeframes, such as an average perceived attitude of a customer or employee for an order. Capturing order attributes or characteristics across different timeframes can help to provide meaningful insights about each order. For example, a high customer satisfaction at the end of a call is likely to indicate that the customer is satisfied with the order overall regardless of customer satisfaction earlier in the order (e.g., because any problems experienced by the customer were resolved by the end of the order).

For purposes of illustration, some examples herein describe using the order analytics module 260 to analyze a single order (e.g., in real time or near-real time). However, it will be appreciated that the order analytics module 260 can analyze any number of orders, including analyzing multiple orders in parallel and taking actions based on multiple orders that overlap in time at least in part. For example, the order analytics module 260 can receive audio information for at least two orders that overlap in time, at least in part. The order analytics module 260 can further identify one or more characteristics of the at least two overlapping orders (e.g., perceived attitude and/or customer satisfaction), and the order analytics module 260 can take one or more actions in response to each of the at least two overlapping orders (e.g. causing a visual indicator to be displayed and/or causing an audio indicator to be played). Thus, the disclosed system provides one or more technical improvements that enable analysis of multiple orders that are simultaneous and/or at least partially overlapping.

After an order is analyzed by the order analytics module 260, the order analytics system 130 can store various information about the order and/or analysis of the order. For example, the system 130 can store order audio and corresponding order data, one or more metrics (e.g., ratings) associated with the order, and one or more actions taken in response to the order. Such information may be stored by the system in a scorecard associated with the corresponding audio and order information. The system 130 can subsequently use the stored data to assess accuracy of the one or more machine learning models, retrain one or more machine learning models, assess employee or restaurant performance, and so forth.

FIG. 3A is a flow diagram illustrating a process 300 implemented by the order analytics system 130 to train a machine learning model. In this example implementation, the process 300 is to train a machine learning model to analyze orders placed at a drive-through ordering system of a restaurant based on order interactions (e.g., conversation between a customer and an employee via an intercom). In general, the process 300 includes receiving order interaction data for multiple orders, identifying characteristics of orders, generating a training dataset using the identified characteristics, and training a machine learning model using the training dataset.

The process 300 begins at block 305, where order data is received for multiple orders, such as hundreds or thousands of orders placed via a drive-through ordering system of a restaurant. The order data includes, for each order, recorded and/or transcribed audio of an order interaction, which can be an audio file (e.g., WAV or MP3 file) containing a single interaction between a customer placing an order and an employee taking the order. In some implementations, the order data can also include corresponding order inputs entered by the employee into a computing system of the restaurant, including a list of items ordered by the customer, a price corresponding to each item, and an order total, which can be matched to corresponding order audio, for example, based on respective time stamps for the order audio and the order inputs.

The process 300 then proceeds to block 310, where a scorecard is generated for each of the received orders. The scorecard may be automatically or manually populated and indicate one or more characteristics of a corresponding order, including a perceived employee attitude rating and a perceived customer satisfaction rating. (Certain data captured in the scorecard, such as order time, may be automatically populated. Other data, such as perceived employee attitude rating and perceived customer satisfaction rating, are manually generated since those rating involve interpretation.) In some implementations, the scorecard includes an order accuracy rating, an order time or wait time, and so forth. The one or more characteristics can be extracted and/or calculated from the order data.

The process 300 then proceeds to block 315, where a training dataset is generated. Generating a training dataset can include, for example, gathering sets of orders and corresponding order data based on similarity of characteristics, such as positive or negative customer experience. Training datasets should be selected to have at least an order of magnitude more examples than trainable parameters.

The process 300 then proceeds to block 320, where a machine learning model is trained to analyze orders. That is, the training datasets constructed in block 315 are used to train one or more machine learning models. Those models are trained to analyze audio data (and potentially additional order data) and generate ratings of the employee and customer interaction. For example, the models may be trained to detect low or high customer satisfaction, low or high employee attitude, and so forth. In some implementations, the machine learning model determines one or more thresholds for taking the various actions. For example, these thresholds can be minimum or maximum ratings or other metrics for taking corresponding actions. After the machine learning model has been trained, it can be applied to new data items, such as order audio, and generate one or more ratings that characterize that order.

The depicted process 300 represents just one implementation of training a machine learning model to analyze orders. The operations of process 300 can be altered while still maintaining similar functionality. For example, in some implementations, order data and/or identified order characteristics can be used to generate multiple training datasets each used to train a different machine learning model, such as a first model that rates employee attitude and a second model that rates customer satisfaction.

In some implementations, the process 300 can include evaluating accuracy of a machine learning model and retraining the machine learning model if accuracy is below a threshold (e.g., 90%, 80%, 70% accurate). For example, after a machine learning model is trained, the model can be evaluated from time to time (e.g., weekly, monthly, quarterly, annually) to detect any decrease in accuracy, such as incorrect characterizations of orders (e.g., predicting customer dissatisfaction when a customer is not dissatisfied). In some implementations, a portion (e.g., 10%) of training data is withheld from a training dataset and used as test data to test a machine learning model. In these and other implementations, when accuracy of a machine learning model falls below a threshold level of accuracy, the model can be retrained, for example, by adjusting one or more weights and retraining with the same training dataset, by generating a new (e.g., larger) training dataset, and so forth.

FIG. 3B illustrates a table 340 containing order data that can be used to select corresponding audio data that is used to generate a training dataset. The table 340 includes multiple rows 345, with each row representing a scorecard for an individual order. Column 350 contains a unique identifier assigned for each order. In addition to uniquely identifying each order, these or other identifiers can be used to associate orders with particular restaurant chains or individual restaurant locations. Columns 355 and 360 include start and end times for each order, which can be used to calculate an order duration. Columns 365 and 370 include information about, respectively, a number of items included in an order and a total price of the order. Column 375 indicates whether, for each order, an employee used a “hold greeting,” which is any statement by which an employee greets a customer but does not begin taking the customer's order (e.g., “Welcome to [______]. I'll be with you in a moment.”). The presence or absence of a hold greeting can be used to help determine customer satisfaction or dissatisfaction, for example, because use of a hold greeting likely indicates a longer wait time or order time. Columns 380 and 385 include numerical ratings characterizing order interactions associated with each order, as described herein above, which may be generated automatically and/or manually based on reviewing recorded or transcribed audio of order interactions. For example, a person and/or an automated speech analysis system can review a recording of an order interaction and assign an employee attitude rating, as described above with reference to Table 1 and as shown in column 380. An order interaction can similarly be reviewed to assign a rating of customer satisfaction, as described above with reference to Table 2 and as shown in column 385. The foregoing ratings can be based on various factors, such as tone of voice of an employee or customer, whether all or portions of an order are repeated, and so forth. Column 390 includes a link to an audio file for each order, which can be used to generate one or more training datasets. Table 340 of FIG. 3B is a non-limiting example, and more or fewer data items may be included to characterize orders. For example, in some implementations corresponding actions are also stored, and/or other information about an order, such as an identity of an employee taking the order.

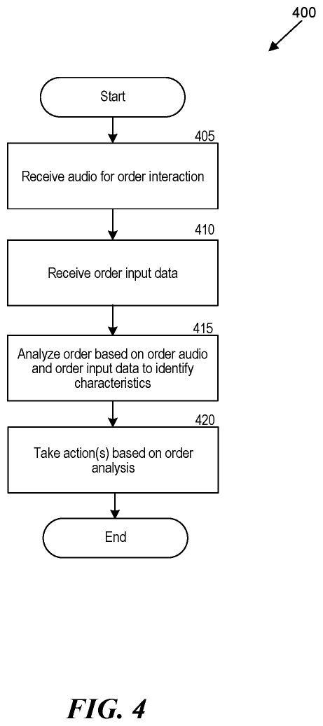

FIG. 4 is a flow diagram that illustrates a process 400 implemented by the order analytics system 130 for analyzing an order based on order audio. In some implementations, the process 400 can also include analyzing orders using order input data. In general, the process includes receiving audio for an order, receiving corresponding order input data, analyzing the order based on the order audio and the order input data, and taking one or more actions based on the order analysis.

The process 400 begins at block 405, where audio is received for an order. In an example implementation, the order is placed via a drive-through system of a restaurant. For example, as depicted in FIG. 1, a customer 105 places an order via an order intake module 115 comprising an intercom system, and an interaction between the customer and an employee of the restaurant is captured by the audio extraction module 120, which transmits audio of the order interaction to the order analytics system 130.

The process 400 then proceeds to block 410, where order input data is received corresponding to the audio received at block 405. For example, as the order is occurring, the employee begins entering items ordered by the customer into a restaurant computing system as order inputs. The restaurant computing system transmits the order data to the order analytics system, where it is correlated with the audio data received from the audio extraction module 120. The correlation may be performed based on the time and date stamps associated with each of the audio data and the order data.

The process 400 then proceeds to block 415, where the order is analyzed based on the order audio and/or the order input data. The order can be analyzed, for example, using one or more machine learning models trained according to process 300 of FIG. 3A. When applied to the audio order data, the ML models identify one or more characteristics of the order, such as employee attitude and customer satisfaction. The one or more characteristics can be associated with a probability score predicting a likelihood, for example, that an employee's attitude is perceived as negative, that a customer is satisfied or dissatisfied, and so forth.

The process 400 then proceeds to block 420, where one or more actions are taken based on the order analysis. In some implementations, the one or more actions taken include generating a periodic report (e.g., daily, weekly, biweekly, monthly, etc.) that can be used by a restaurant or a chain or group of restaurants to assess employee or restaurant performance, overall customer satisfaction, and so forth. In addition, as described herein above, actions taken can include generating audio and/or visual prompts to the employee taking the order, such as prompts via a headset or a graphical user interface to improve the employee's perceived attitude and/or customer satisfaction, prompts to work more quickly, and so forth. In some implementations, these audio and/or visual prompts are generated in real time or near-real time (e.g., while an order is being taken).

The depicted process 400 shown in FIG. 4 represents just one implementation of analyzing an order using an order analytics system according to the present technology. The operations of process 400 can be altered while maintaining similar functionality. For example, one or more operations of the process 400 can be performed in parallel, such as operations of block 405 and 410. Operations of process 400 can also be added or omitted without deviating from the teachings of the present disclosure. For example, receiving order input data at block 410 can be omitted, and analyzing the order at block 415 can be performed based only on the audio received at block 405. In addition, process 400 can include storing at least some data about an order in a database, which can be used to evaluate employee or restaurant performance, to assess accuracy of a machine learning model, and/or to retrain a machine learning model.

In some implementations, the process 400 can be performed in parallel for multiple orders that overlap in time at least in part. For example, the order analytics system can perform the process 400 to analyze overlapping orders that are being taken in different lanes of a single drive-through restaurant. Additionally or alternatively, the order analytics system can perform the process 400 to analyze overlapping orders occurring at different locations (e.g., at two or more restaurants in a chain of restaurants).

While the above description contemplates the recording and subsequent analysis of each order at a later time, certain changes can be made to the architecture to allow for the analysis of orders in near real-time. To enable such on-the-fly analysis of orders, the order audio would be concurrently streamed to the order analytics system 130. As the order audio data is received, it would be processed by one or more ML models to characterize the order. Based on the ongoing characterization, the system 130 could transmit immediate audio or visual feedback to an employee, such as when an employee's attitude is perceived as negative, when an employee should increase the speed of order taking, and so forth, to provide feedback to the employee to correct their approach with the customer.

In general, the detailed description of embodiments of the present technology is not intended to be exhaustive or to limit the present technology to the precise form disclosed above. While specific embodiments of, and examples for, the present technology are described above for illustrative purposes, various equivalent modifications are possible within the scope of the present technology, as those skilled in the relevant art will recognize. For example, while processes (or steps) or blocks are presented in a certain order, alternative embodiments can perform routines having steps, or employ systems having blocks, in a different order, and some processes or blocks can be deleted, moved, added, subdivided, combined, and/or modified. Each of these processes or blocks may be implemented in a variety of different ways. Also, while processes or blocks are at times shown as being performed in series, these processes or blocks may instead be performed in parallel, or can be performed at different times.

These and other changes can be made to the disclosed technology in light of the above Detailed Description. While the above description describes certain examples of the disclosed technology, no matter how detailed the above appears in text, the disclosed technology can be practiced in many ways. Details of the systems and methods may vary considerably in their specific implementations, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms.

I/We claim:

1. A system to analyze audio data associated with orders, the system comprising:
at least one hardware processor; and
at least one non-transitory memory carrying instructions that, when executed by the system, cause the system to perform operations comprising:
receiving audio data for multiple orders provided by customers over an intercom system,
wherein the audio data includes, for each of the multiple orders, speech of a customer placing the order and speech of an employee taking the order,
wherein the audio data is received from at least one audio extraction module that captures the audio data in response to detecting a presence of the customer, and
wherein the at least one audio extraction module captures the audio data via the intercom system;
applying an order analysis model to characterize the audio data for the multiple orders, the characterization of the audio data including an estimated customer satisfaction or a perceived employee attitude for at least some of the multiple orders; and
generating a recommendation based at least in part on the characterization of the audio data, the recommendation including a recommended change in behavior of the employee to improve the estimated customer satisfaction or the perceived employee attitude.

2. The system of claim 1 wherein:
two or more orders of the multiple orders overlap in time, at least in part; and
the recommendations for each of the two or more orders are generated in parallel.

3. The system of claim 1, wherein detecting the presence of the customer includes detecting an audio tone generated in response to detecting presence of a vehicle using an inductive loop, a magnetometer, or a radar sensor.

4. The system of claim 1, wherein the order analysis model comprises a machine learning model trained, using a training dataset, to characterize the audio data.

5. The system of claim 1, wherein audio data associated with multiple orders are received in a single aggregate data file.

6. The system of claim 1, wherein the characterization of the audio data is stored in a scorecard associated with the order.

7. The system of claim 1, wherein the operations further comprise:
causing display of a visual indicator of the generated recommendation at a graphical user interface of a computing system used by the employee taking the order.

8. The system of claim 1, wherein the operations further comprise:
causing an audio indicator of the generated recommendation to be played via a speaker or headset via which the employee accesses the intercom system.

9. The system of claim 1, wherein the generated recommendation includes a recommendation to upsell or a recommendation for a supervisor to intervene in the order.

10. The system of claim 1, wherein the characterization of the audio data includes an order wait time or an order duration.

11. The system of claim 1, wherein characterizing the audio data includes detecting profanity or other inappropriate language in the audio data.

12. A system to capture audio data associated with orders for analysis, the system comprising:
at least one hardware processor; and
at least one non-transitory memory carrying instructions that, when executed by the system, cause the system to perform operations comprising:
detecting presence of a customer at an intercom system associated with a physical service location;
capturing audio data for an order via the intercom system, the audio data including speech of the customer placing the order and speech of an employee taking the order;
associating the audio data with supplemental information including:
an identifier of the physical service location;
an identifier of the employee taking the order; and
a time stamp of the order; and
transmitting the audio data for the order and supplemental information to an order analytics system, the order analytics system being configured to:
characterize the audio data based on an estimated customer satisfaction or a perceived employee attitude;
generate a report characterizing the performance of the employee in taking the order; and
transmit the generated report to a computing system associated with the physical service location.

13. The system of claim 12, wherein detecting the presence of the customer and the intercom system includes detecting an audio tone generated in response to detecting presence of a vehicle using an inductive loop, a magnetometer, or a radar sensor.

14. The system of claim 12, wherein the order analytics system comprises a machine learning model trained, using a training dataset, to characterize the audio data.

15. The system of claim 12, wherein the supplemental information further includes a list of items in the order.

16. The system of claim 12, wherein the operations further comprise:
detecting an end of the order; and
terminating capture of the audio data in response to detecting the end of the order.

17. The system of claim 12, wherein transmitting the audio data for the order and supplemental information comprises:
storing audio data and supplemental information for multiple orders; and
transmitting the audio data and supplemental information for multiple orders in aggregate.

18. The system of claim 17, wherein the operations further comprise compressing or encrypting the audio data and supplemental information before transmission.

19. They system of claim 17, wherein the operations further comprise pre-processing the audio to remove silence, to normalize a volume level, or to remove noise.

20. A computer-implemented method to analyze audio data associated with orders, the method comprising:
receiving audio data for multiple orders provided by customers over an intercom system,
wherein the audio data includes, for each of the multiple orders, speech of a customer placing the order and speech of an employee taking the order,
wherein the audio data is received from at least one audio extraction module that captures the audio data in response to detecting a presence of the customer, and
wherein the at least one audio extraction module captures the audio data via the intercom system;
applying an order analysis model to characterize the audio data for the multiple orders, the characterization of the audio data including an estimated customer satisfaction or a perceived employee attitude for at least some of the multiple orders; and
generating a recommendation based at least in part on the characterization of the audio data, the recommendation including a recommended change in behavior of the employee to improve the estimated customer satisfaction or the perceived employee attitude.

21. The method of claim 20, wherein:
two or more orders of the multiple orders overlap in time, at least in part; and
the recommendations for each of the two or more orders are generated in parallel.

22. The method of claim 20, wherein detecting the presence of the customer includes detecting an audio tone generated in response to detecting presence of a vehicle using an inductive loop, a magnetometer, or a radar sensor.

23. The method of claim 20, wherein the order analysis model comprises a machine learning model trained, using a training dataset, to characterize the audio data.

24. The method of claim 20, further comprising:
causing display of a visual indicator of the generated recommendation at a graphical user interface of a computing system used by the employee taking the order.

25. The method of claim 20, further comprising:
causing an audio indicator of the generated recommendation to be played via a speaker or headset via which the employee accesses the intercom system.

26. The method of claim 20, wherein the characterization of the audio data is stored in a scorecard associated with the order.
